(19) United States
(12) Patent Application Publication
(10) Pub. No.: US 2024/0083271 A1
(43) Pub. Date: Mar. 14, 2024

(54) A CHARGING STATION WITH AN ILLUMINATED CONNECTOR

(71) Applicant: Zaptec IP AS, Stavanger (NO)

(72) Inventors: Knut Braut, Sandnes (NO); Fredrik Østrem, Sandnes (NO); Magnus Pallesen, Stavanger (NO)

(73) Assignee: Zaptec IP AS, Stavanger (NO)

(21) Appl. No.: 18/275,280

(22) PCT Filed: Feb. 4, 2022
(86) PCT No.: PCT/EP2022/052750

§ 371 Date: Aug. 1, 2023

(30) Foreign Application Priority Data
Feb. 5, 2021 (NO) 20210147

(51) Int. Cl. B60L 53/16; H01R 13/717

(52) U.S. Cl. CPC B60L 53/16; H01R 13/7175

(57) ABSTRACT

A charging station, which is for charging an electric vehicle, includes an outer housing containing controller and power electronics mounted to at least one printed circuit board; an interface enabling connection of the charging station to the electric vehicle; and at least one light source connected to the at least one printed circuit board. The interface is a connector made of a translucent or semi-translucent material in at least an area of the connector directed at the light source.

### TECHNICAL FIELD

The invention relates to a charging system for charging an electric vehicle, and more specifically to details of an illuminated connector and its light source.

### BACKGROUND

Electrical vehicles have become increasingly popular and as such, there are a range of different charging solutions available on the market. Charging solutions range from public fast charging stations to charging stations for home use.

A wall mounted charging station, typically adapted for home use, comprises different parts including an outer housing holding electronics mounted to one or more circuits boards, and an interface enabling connection of the charging station to an electric vehicle. The interface is a connector for connecting a charging cable that is connected to the electric vehicle.

When a charging station is installed in a lit surrounding the connector where the charging cable shall be inserted will be visible. This will be the case in daylight or if the installation location of the charging station is well lit with suitable light sources. However, if the location where the charging station is installed is dark, it will be difficult to see the connector where a charging plug of the charging cable shall be inserted.

There are solutions where the location of a charging station is indicated by for instance a blinking LED on the charging station, or by a light source connected to the connector of the charging station.

The present invention provides an alternative solution that is both simple and effective, where the connector emits light from a light source apart from the connector.

### SUMMARY

The invention is defined by a charging station for charging an electric vehicle. The charging station comprises an outer housing containing controller and power electronics mounted to at least one printed circuit board and an interface enabling connection of the charging station to the electric vehicle. The charging station is characterized in further comprising at least one light source connected to the at least one printed circuit board, and where the interface is a connector made of a translucent material in at least an area of the connector directed at the light source.

Further characteristics of the invention are defined in the claims.

### DETAILED DESCRIPTION

The invention will now be described with reference to the figures.

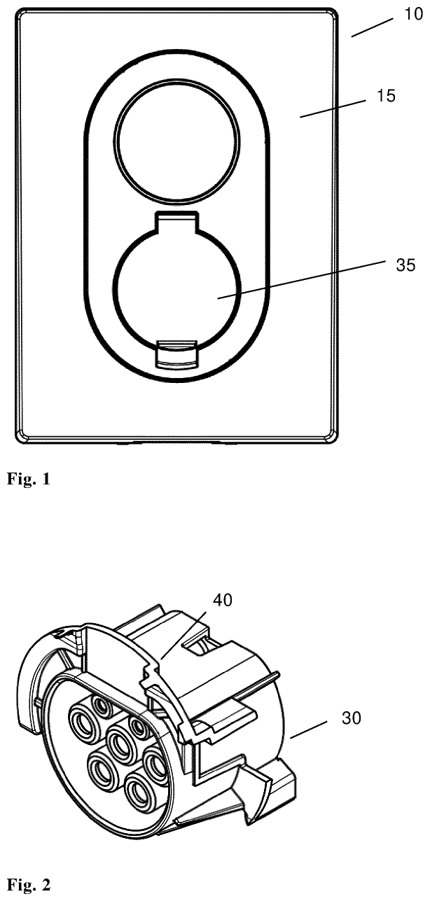

FIG. 1 illustrates a charging station where the invention is implemented;

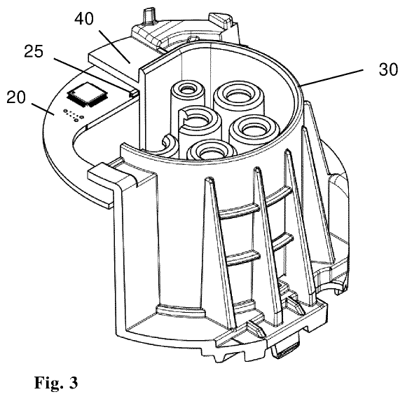

FIG. 2 illustrates an example of a connector of the charging station, and

FIG. 3 illustrates a location of a connector relative to a printed circuit board and light source.

FIG. 1 illustrates an example of a charging station 10 where the invention is implemented. The illustration shows a wall mounted charging station 10.

The charging station 10 has an interface enabling connection to an electric vehicle. The interface is a connector 30 adapted for receiving a plug connected to one end of a charging cable where the other end of the charging cable is connected to a plug adapted to be inserted in a connector of the electric vehicle. In the figure, a lid 35 is covering the connector 30 shown in FIG. 2.

FIG. 2 illustrates an example of a connector 30. This is a standard moulded Type-2 connector. This is connected to the power electronics of the charging station which in turn is connected to an external power supply.

The charging station comprises controller electronics for controlling power flowing through the connector 30. The controller electronics and the power electronics can be mounted to same or different printed circuits boards. According to the invention, the charging station comprises at least one light source 25 that is connected to the at least one printed circuit board 20.

FIG. 3 illustrates a location of a connector 30 relative to a printed circuit board 20 and light source 25. The connector 30 is made of a translucent material in at least an area 40 of the connector 30 that is directed at the light source 25. In this way, the connector 30 is placed such that light from the light source 25 can flow through the translucent area 40 of the connector, as illustrated in FIG. 3. The light source mounted on the printed circuit card 20 can be angled to direct most of the emitted light towards the connector 30.

According to one embodiment of the invention, the connector 30 is provided with a translucent protection lid 35. In this way, light emitted from the light source 25 will also be visible through the lid 35.

According to one embodiment of the invention, the connector 30 is made entirely of a translucent or semi-translucent material, e.g. moulded plastic.

According to one embodiment, the translucent or semi-translucent area 40 directed at the light source 25 is matted by surface treatment. This solution will spread light flowing through the connector 30 more evenly.

According to one embodiment of the invention, the light source 25 is an LED, preferably a power LED's. According to another embodiment of the invention, there are two or more light sources mounted to the printed circuit board 20 for spreading light through the connector 30 at different translucent and/or semi-translucent areas of the connector 30.

According to one embodiment, a more precise directing of light from the light source 25 to the connector 30 is provided by using one or more light pipes installed between the light source 25 and the connector 30.

According to one embodiment of the invention, the at least one light source is single- or multi-coloured. In this way, the controller electronics of the charging station 10 can control the light source to indicate status of the charging station 10.

The solution presented above provides a simple and effective solution for indicating where a plug of a charging cable of an electric vehicle shall be inserted in dark environments. By mounting the light source 25 for the connector 30 to the printed circuit board 20 of the charging station, production cost is reduced considerable compared to prior known solutions providing light indication of where a connector of a charging station is located.

1. A charging station for charging an electric vehicle, the charging station comprises:
an outer housing containing controller and power electronics mounted to at least one printed circuit board;
an interface enabling connection of the charging station to the electric vehicle;
at least one light source connected to the at least one printed circuit board, wherein
the interface is a connector made of a translucent or semi-translucent material in at least an area of the connector directed at the light source.

2. The charging station according to claim 1, where the connector is provided with a translucent semi-translucent protection lid.

3. The charging station according to claim 1, wherein the connector is made entirely of a translucent or semi-translucent material.

4. The charging station according to claim 1, wherein the translucent or semi-translucent area directed at the light source is matted by surface treatment.

5. The charging station according to claim 1, wherein the at least one light source is one or more power LEDs.

6. The charging station according to claim 1, wherein the at least one light source is single- or multi-coloured.

7. The charging station according to claim 1, where the at least one light source is directing light to the connector via one or more light pipes.

8. The charging station according to claim 1, where the controller electronics controls the light source to indicate charger status.
